(19) United States
(12) Patent Application Publication
(10) Pub. No.: US 2007/0188532 A1
(43) Pub. Date: Aug. 16, 2007

(54) Nozzle control device and method

(75) Inventors: Sung-wook Kim, Suwon-si (KR); Seung-Ioo Shin, Seoul (KR); Byung-hun Kim, Hwaseong-si (KR); Sang-il Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/654,605

(22) Filed: Jan. 18, 2007

(30) Foreign Application Priority Data
Feb. 10, 2006 (KR) 2006-12914

(51) Int. Cl. B41J 29/38

(52) U.S. Cl. 347/10

(57) ABSTRACT

A nozzle control method and a nozzle control device. The nozzle control method includes discriminating between the nozzle(s) to eject the ink droplets from the nozzle(s) not to eject the ink droplets; and generating a pressure wave with a predetermined amplitude in the nozzle(s) not to eject the ink droplets when the ink droplets are ejected from the nozzle(s) to eject the ink droplets. Accordingly, it is possible to produce a color filter with a uniform thickness regardless of the print pattern. The ink droplets with a constant size can be ejected when the nozzle pitch of the print head is not the same width as the print pattern width. Therefore, the print quality is improved by a uniformizing ink thickness in which the print job is performed to the print medium regardless of the number of nozzles ejecting the ink droplets concurrently.

### CROSS-REFERENCE TO RELATED APPLICATIONS

This application claims priority under 35 U.S.C. §119(a) from Korean Patent Application No. 10-2006-0012914, filed on Feb. 10, 2006, in the Korean Intellectual Property Office, the disclosure of which is incorporated herein in its entirety by reference.

### BACKGROUND OF THE INVENTION

1. Field of the Invention

The present general inventive concept relates to an image forming apparatus such as a printer, a facsimile, or a multi function peripheral device, and more particularly, to an inkjet type image forming apparatus which ejects ink droplets onto a print medium from a plurality of nozzles included in a print head.

2. Description of the Related Art

Generally, an inkjet print head includes a plurality of nozzles that eject minute droplets of print ink onto a desired location on a print medium such as print paper, and prints an image in a predetermined color. The inkjet print head can be classified into two types according to an ejection mechanism of the ink droplets. In the first type of inkjet print head, a thermal type of inkjet print head generates bubbles in the ink using a thermal source and ejects ink droplets by an expansion force of the bubbles. In the second type of inkjet print head, a piezoelectric type of inkjet print head uses a piezoelectric element and ejects ink droplets by applying a pressure to the ink wherein the pressure is caused by a deformation of the piezoelectric element.

As illustrated in FIGS. 1A and 1B, in an image forming apparatus in which a nozzle pitch is not the same as a width of a print pattern, as in cases 110, 120, 140, and 150 of FIG. 1A, and 200 and 220 of FIG. 2A, nozzles located outside of a color field may exist when a print job is being performed. In the above case, since the ink droplets are not ejected from the nozzle not located in the color field, the number of nozzles ejecting the ink droplets changes. For example, in case 110 of FIG. 1A, the ink droplets are not ejected from all five nozzles, but ejected from only one nozzle located within the color field.

When the number of nozzles ejecting the ink droplets changes, a pressure wave generated in a pressure chamber included in the nozzle to eject the ink droplets forms pressure in the pressure chamber of a peripheral nozzle. Since the size of the ejected ink droplets vary as the number of nozzles ejecting the ink droplets decreases, the size of the ink droplets increases.

FIGS. 1A and 1B illustrate a case where an ink thickness is not uniform due to the influence of a Y-direction width of the print head. FIGS. 2A and 2B illustrate a case where the ink thickness is not uniform due to the influence of an X-direction width of the print head.

Referring to FIG. 3, in an area 300 corresponding to a period when the print head enters the color field, the ink droplets that are larger than reference sized droplets are ejected, and the size of the ink droplets decreases from left to right across a row and down a column. When the ink droplets are ejected from all of the nozzles, as in an area 310, ink droplets that are of the same size as the reference ink droplets are printed. In an area 320 corresponding to the period when the print head enters the color field, the size of the ink droplets increases from left to right across the row and down the column and the ink thickness also increases.

As explained with respect to the conventional inkjet type image forming apparatus, when the nozzle pitch of the inkjet print head is not the same as the print pattern width or when the ink droplets are not ejected from some nozzles, the size of the ejected ink droplets varies according to the number of nozzles ejecting the ink droplets and a color reproduction rate is reduced, thus resulting in low print quality.

### SUMMARY OF THE INVENTION

The present general inventive concept provides a nozzle control method and a nozzle control device to create uniform ink thickness by generating a pressure wave with an amplitude at which ink droplets are not ejected from a portion of the nozzles not to eject the ink droplets when the ink droplets are ejected from a portion of the nozzles to eject the ink droplets.

The present general inventive concept also provides a nozzle control method and a nozzle control device to create uniform ink thickness by generating heat to a temperature at which ink droplets are not ejected by a nozzle not to eject the ink droplets when the ink droplets are ejected from a nozzle to eject the ink droplets.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a nozzle control method, the method including discriminating between a nozzle to eject ink droplets and a nozzle not to eject the ink droplets, and generating a pressure wave with a predetermined amplitude in the nozzle not to eject the ink droplets when the ink droplets are ejected by the nozzle to eject the ink droplets.

The foregoing and/or other aspects of the present general inventive concept are also achieved by providing a nozzle control device, the device including a nozzle discriminator to discriminate between a nozzle to eject ink droplets and a nozzle not to eject the ink droplets and a pressure wave generator to generate the pressure wave with a predetermined amplitude in the nozzle not to eject the ink droplets when the ink droplets are ejected by the nozzle to eject the ink droplets.

The foregoing and/or other aspects of the present general inventive concept are also achieved by providing a nozzle control method, the method including discriminating between a nozzle to eject ink droplets and a nozzle not to eject the ink droplets and generating heat of a predetermined temperature in the nozzle not to eject the ink droplets when the ink droplets are ejected by the nozzle to eject the ink droplets.

The foregoing and/or other aspects of the present general inventive concept are also achieved by providing a nozzle control device, the device including: a nozzle discriminator to discriminate between a nozzle to eject ink droplets and a nozzle not to eject the ink droplets from a plurality of nozzles and a heat generation unit to generate heat of a predetermined temperature in the nozzle not to eject the ink droplets when the ink droplets are ejected by the nozzle to eject the ink droplets.

The foregoing and/or other aspects and utilities of the present general inventive concept are also achieved by providing a nozzle control method, the method including reading an amplitude of a pressure wave from a storage medium in which the amplitude of the pressure wave with respect to each nozzle is stored in correspondence with a location on a print medium to which ink droplets are ejected and generating the pressure wave in each nozzle in accordance with the read amplitude of the pressure wave, wherein the storage medium stores a predetermined amplitude of the pressure wave so that the pressure wave is generated with respect to a nozzle not to eject the ink droplets.

The foregoing and/or other aspects of the present general inventive concept are also achieved by providing a nozzle control device, the device including a pressure wave amplitude storage unit to store the amplitude of the pressure wave with respect to each nozzle in correspondence with a location on a print medium to which ink droplets are ejected and a pressure wave generator to generate the pressure wave in each nozzle in accordance with the amplitude of the pressure wave stored in the pressure wave amplitude storage unit, wherein a predetermined amplitude of the pressure wave is stored in the pressure wave amplitude storage unit so that the pressure wave is generated in the pressure wave generator with respect to a nozzle not to eject the ink droplets.

The foregoing and/or other aspects and utilities of the present general inventive concept are also achieved by providing a nozzle control method, the method including reading heat temperature from a storage medium in which the heat temperature to be generated is stored with respect to each nozzle in correspondence with a location on a print medium to which ink droplets are ejected and generating the heat in each nozzle by the read temperature, wherein a predetermined temperature of the heat is stored in the storage medium so that the heat is generated with respect to a nozzle not to eject the ink droplets.

The foregoing and/or other aspects and utilities of the present general inventive concept are also achieved by providing a nozzle control device, the device including a temperature storage unit to store a temperature of heat to be generated in each nozzle in correspondence with a location on a print medium to which ink droplets are ejected and a heat generation unit to generate heat in each nozzle in accordance with the temperature stored in the temperature storage unit, wherein a predetermined temperature of the heat is stored in the temperature storage unit so that the heat is generated with respect to a nozzle not to eject the ink droplets.

The foregoing and/or other aspects of the present general inventive concept also are achieved by providing a nozzle controlling device to control a nozzle in an image forming apparatus so as to eject ink droplets from a plurality of nozzles, the device includes a nozzle discriminator to discriminate a nozzle to eject the ink droplets from a nozzle not to eject the ink droplets and a generator to activate the nozzles such that the nozzles to eject the ink droplets do eject the ink droplets and the nozzles not to eject the ink droplets do not eject the ink droplets.

The generator can take the form of a pressure wave generator to apply a pressure in all of the nozzles such that the nozzles to eject the ink droplets do eject the ink droplets and the nozzles not to eject the ink droplets do not eject the ink droplets.

The generator can take the form of a heat generation unit to apply heat in all of the nozzles such that the nozzles to eject the ink droplets do eject the ink droplets and the nozzles not to eject the ink droplets do not eject the ink droplets.

The foregoing and/or other aspects of the present general inventive concept also are achieved by providing a method of controlling nozzles in an image forming apparatus, the method comprising determining which nozzles of a plurality of nozzles are to eject the ink droplets and generating a pressure wave with a predetermined amplitude and applying the pressure wave to the plurality of nozzles to eject the ink droplets.

An amplitude of the pressure wave generated can be controlled using a weight factor which relatively represents the amplitude of the pressure wave generated in each nozzle.

The pressure wave generated in the nozzle to eject the ink droplets can be dispersed over the nozzles not to eject the ink droplets.

In regions where the ink droplets are not to be ejected from some nozzles, the amplitude of the pressure wave can be multiplied by a weight factor of 0.5, and in a region where the ink droplets are to be ejected from all nozzles, the amplitude of the pressure wave can be multiplied by a weight factor of 1.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A to 3 are views illustrating problems of a conventional inkjet type image forming apparatus;

FIG. 4 is a flowchart illustrating a nozzle control method according to an embodiment of the present general inventive concept;

FIG. 5 is a flowchart illustrating a nozzle control method according to another embodiment of the present general inventive concept;

FIG. 6 is a block diagram illustrating a nozzle control device according to another embodiment of the present general inventive concept;

FIG. 7 is a block diagram illustrating a nozzle control device according to another embodiment of the present general inventive concept;

FIG. 8 is a block diagram illustrating a nozzle control device according to another embodiment of the present general inventive concept;

FIG. 9 is a block diagram illustrating a nozzle control device according to another embodiment of the present general inventive concept;

FIG. 10 is a view illustrating a nozzle control device and a method according to the present general inventive concept;

FIG. 11 is a graph illustrating a relationship between a case where only pressure waves are generated in peripheral nozzles and a case where ink droplets are ejected from the peripheral nozzles;

FIGS. 12A to 12C are graphs illustrating operation 414 in FIG. 4, a weight factor allocator 613 in FIG. 6, and a weight factor allocator 713 in FIG. 7; and

FIG. 13 illustrates a weight factor pattern used for operation 414 in FIG. 4, a weight factor allocator 613 in FIG. 6, and a weight factor allocator 713 in FIG. 7.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

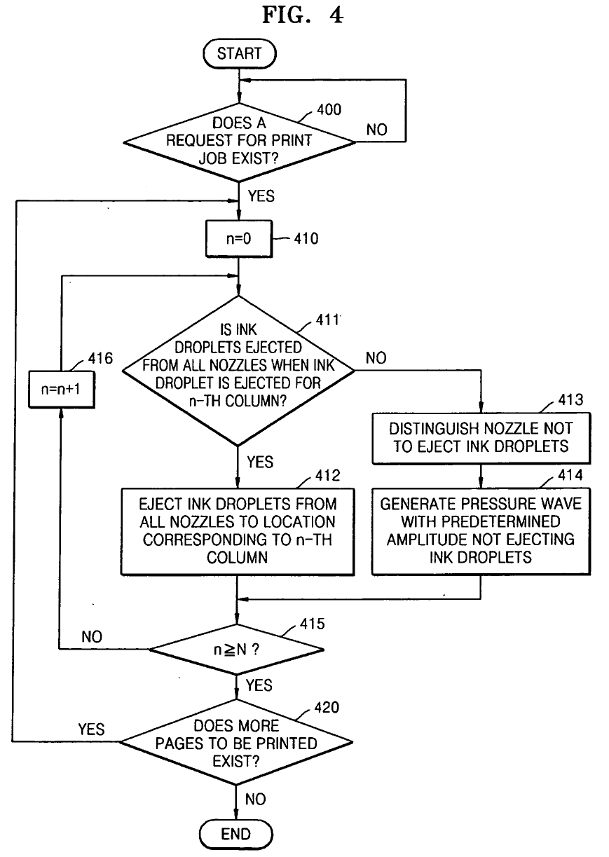

FIG. 4 is a flowchart illustrating a nozzle control method according to an embodiment of the present general inventive concept.

Referring to FIG. 4, it is first determined whether a request for a print job from a host device, such as a personal computer (PC), exists in operation 400.

When it is determined that the request for the print job exists in operation 400, a print column of which value is n is set to an initial value of 0 in operation 410. Here, the n-th column of the print job is a column corresponding to the job in which a print head, including a plurality of nozzles, ejects ink droplets onto a print medium, such as a print paper.

After operation 410, it is determined whether the ink droplets are to be ejected from all of the nozzles when performing a job of ejecting ink droplets for the n-th print column in operation 411.

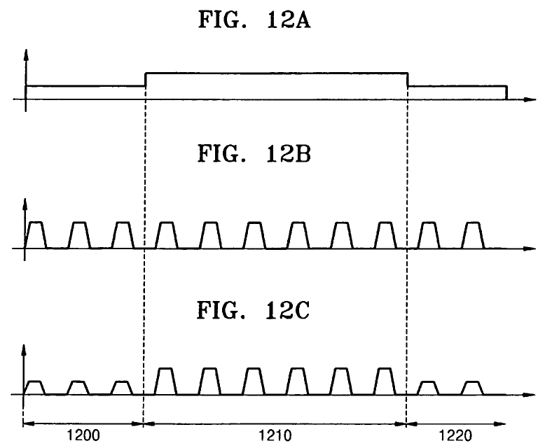

When it is determined that ink droplets are to be ejected from all of the nozzles in operation 411, ink droplets are ejected from all the nozzles by a pressure wave with a constant amplitude generated in a pressure chamber included in each nozzle to a location on the print medium corresponding to the n-th print column in operation 412. As illustrated in FIG. 12B, the pressure wave generated in operation 412 has the constant amplitude as described above.

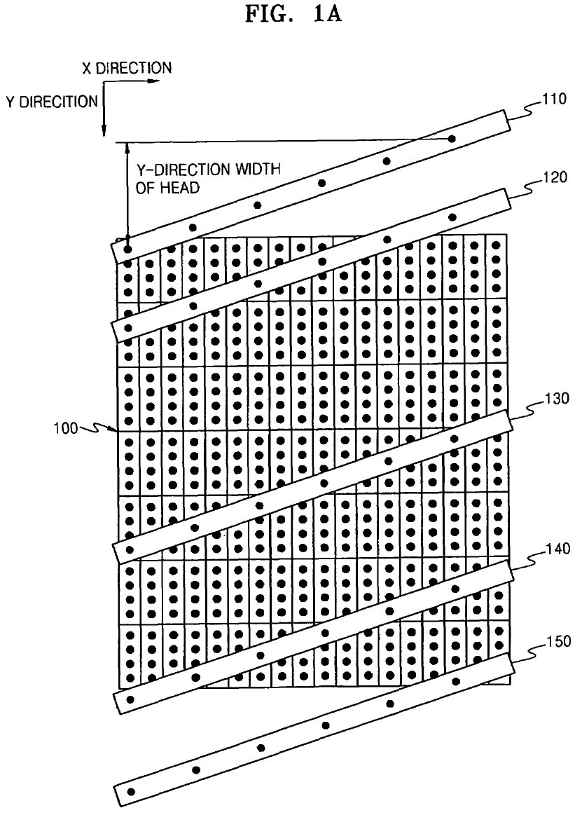

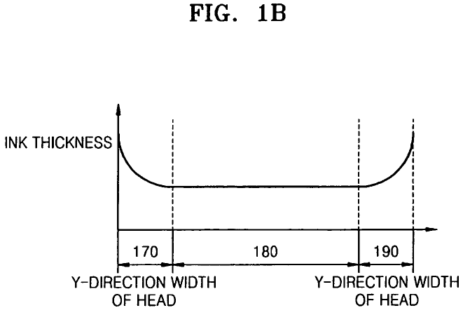

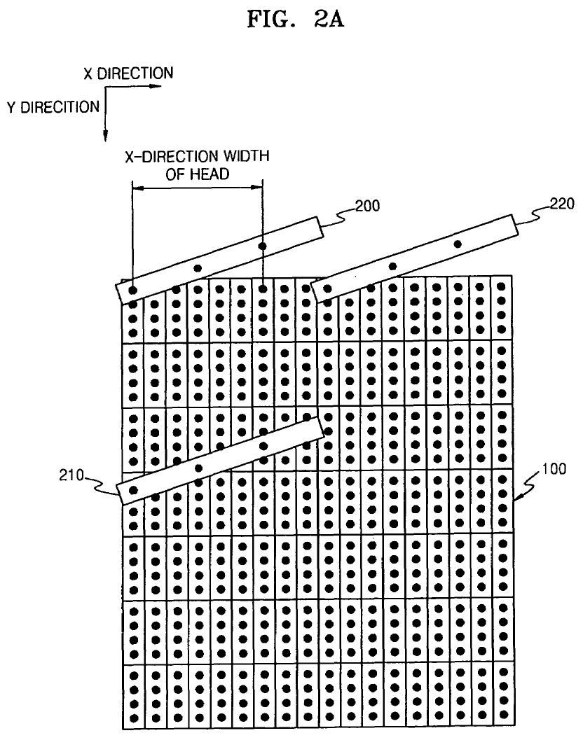

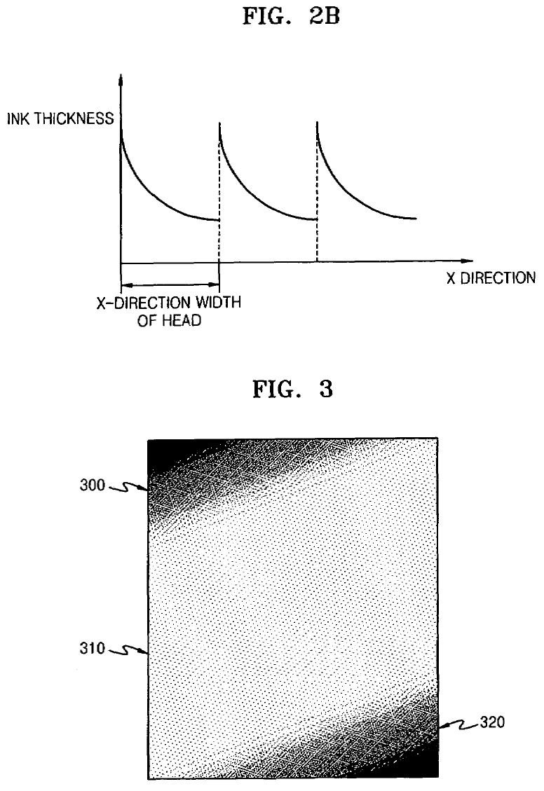

When it is determined that the ink droplets are not to be ejected from some nozzles in operation 411, a nozzle not to eject the ink droplets is discriminated from a nozzle to eject the ink droplets when performing the job of ejecting the ink droplets for the n-th print column (413). In this embodiment, the nozzle not to eject the ink droplets is the nozzle located outside of the color field, as in cases of positions 110, 120, 140, and 150 illustrated in FIG. 1A, since the print pattern width is not the same as a nozzle pitch of the print head in a color filter print process, or a nozzle which passes a black matrix.

When the ink droplets are ejected from the nozzle to eject the ink droplets to perform the n-th print column or after a predetermined period of the time has elapsed, the pressure wave with the predetermined amplitude is generated in operation 414, even for the nozzle not to eject the ink droplets, in operation 413. The amplitude of the pressure wave generated in operation 414 is the amplitude at which the ink droplets are not to be ejected from the nozzle, and the amplitude can be determined by an experimental result or by experience.

The amplitude of the pressure wave generated in operation 414 can be controlled using a weight factor which relatively represents the amplitude of the pressure wave generated in each nozzle. For example, FIG. 12A is a graph illustrating a weight factor which represents the amplitude of the pressure wave to be generated in each nozzle. Here, regions 1200 and 1220 correspond to the weight factor of the nozzle(s) not to eject the ink droplets, and a region 1210 corresponds to the weight factor of the nozzle(s) to eject the ink droplets. The weight factor illustrated in FIG. 12A is calculated with a drive waveform of the pressure wave illustrated in FIG. 12B to obtain the drive waveform to be generated in the pressure chamber included in each nozzle as illustrated in FIG. 12C. When the pressure wave generated in the pressure chamber is controlled in accordance with the calculated drive waveform of the pressure wave, in the regions 1200 and 1220, the ink droplets are not ejected and the pressure wave generated in the pressure chamber is only dispersed, and in the region 1210, the ink thickness ejected onto the print medium is uniform as in a region 180 illustrated in FIG. 1B.

When the ink droplets are ejected from the nozzle to eject the ink droplets or after a predetermined period of the time, the size of the ejected ink droplets are almost uniform regardless of the number of nozzles that are ejecting the ink droplets due to generating the pressure wave with the predetermined amplitude and applying the pressure wave to the nozzles to eject the ink droplets as well as to the discriminated nozzle(s) not to eject the ink droplets in operation 414. For example, referring to FIG. 10, it is assumed that an ink droplet 1050 is not ejected from the nozzles 1000, 1010, 1030 and 1040, but is ejected from the nozzle 1020. In operation 414, when the ink droplets are ejected from the nozzle 1020, the pressure wave with the amplitude at which the ink droplets are not to be ejected is generated in the nozzles 1000, 1010, 1030, and 1040 that do not eject the ink droplets. The pressure wave to be generated in the nozzle 1020 to eject the ink droplets is dispersed over the nozzles 1000, 1010, 1030, and 1040, and therefore, the ink droplets having the same size as the reference sized droplet are ejected.

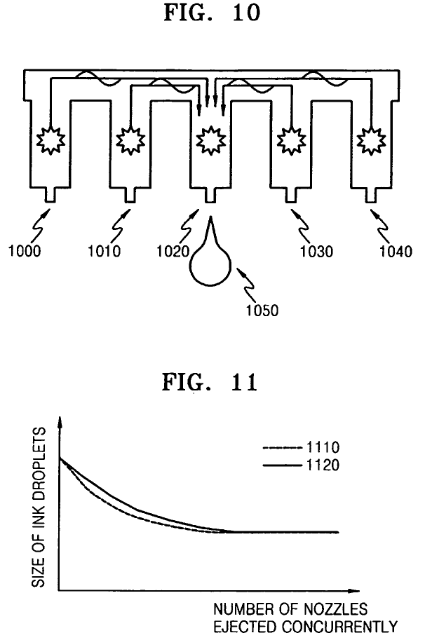

The graph at FIG. 11 illustrates a relationship between the number of the nozzles ejecting the ink droplets concurrently and the size of the ink droplets. A curve 1110 illustrates a case where the ink droplets are ejected from peripheral nozzles, and a curve 1120 illustrates a case where the ink droplets are not ejected from the peripheral nozzles and only pressure waves are generated in the peripheral nozzles. Even when the pressure wave with the amplitude at which the ink droplets are not ejected is generated, the ink droplets that are ejected have approximately the same size as the size of the ink droplets in a case where the ink droplets are ejected from the peripheral nozzles.

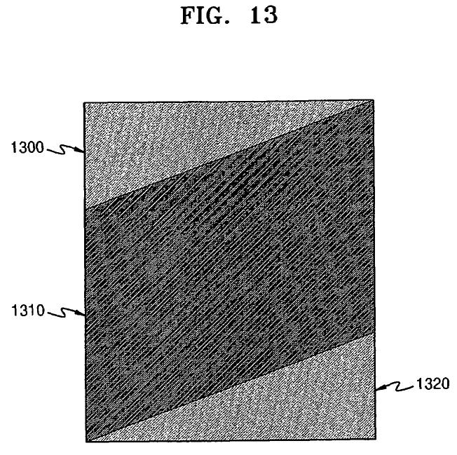

In addition, FIG. 13 illustrates weight factors with respect to the print pattern used in operation 414. In regions 1300 and 1320 where the ink droplets are not ejected from some nozzles, the amplitude of the pressure wave is multiplied by a weight factor of 0.5, and in a region 1310 where the ink droplets are ejected from all nozzles, the amplitude of the pressure wave is multiplied by a weight factor of 1.

In operation 415, it is determined whether the n-th print column is the N-th column that is a termination column. Here, the termination column is a final column in which a print job has to be terminated in a unit print job corresponding to one page.

When it is determined that a print column number n is equal to or less than a termination column number N in operation 415, the print column number n is set to n+1 in operation 416, and when the job of ejecting the ink droplets with respect to the n-th print column is performed, it is determined whether the ink droplets are ejected from all the nozzles in operation 411.

When it is determined that the print column number n is greater than the termination column number of N in operation 415, it is determined whether pages to be printed still remain, in operation 420.

When it is determined that pages to be printed still remain, in operation 420, the print column number n is set to 0 to print the next page in operation 410.

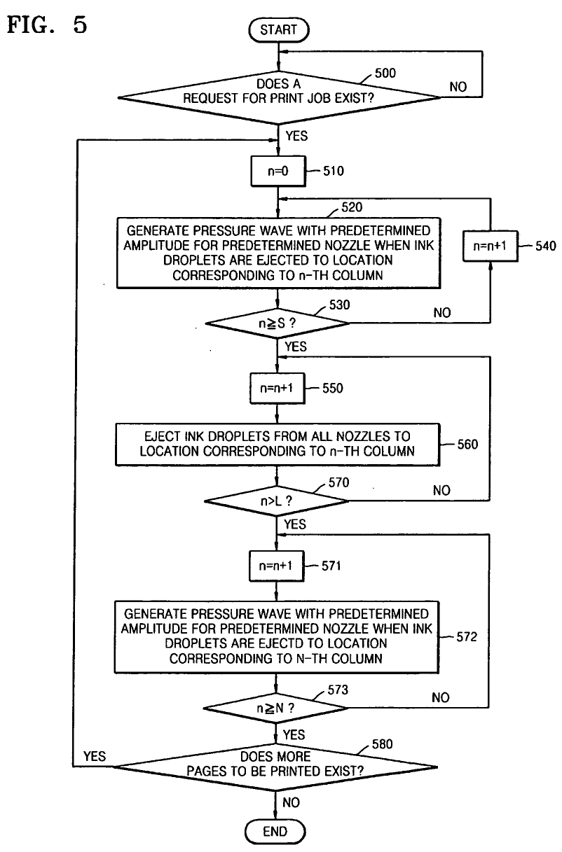

FIG. 5 is a flowchart illustrating a nozzle control method according to another embodiment of the present general inventive concept.

Referring to FIG. 5, in operation 500, it is determined whether a request for a print job from a host device, such as a PC, exists.

When it is determined that the request for a print job exists in operation 500, a print column n is set to an initial value of 0 in operation 510.

After operation 510 is performed, if the ink droplets are ejected from the nozzles at a location of the print medium corresponding to the n-th print column or after a predetermined period of the time, the pressure wave with the predetermined amplitude is generated for the predetermined nozzles in operation 520.

Here, the predetermined nozzles are the nozzles not to eject the ink droplets at the n-th print column since the print pattern width is not the same width as the nozzle pitch of the print head in a color filter print process. In addition, the amplitude of the pressure wave generated in operation 520 is the amplitude at which the ink droplets are not ejected, and the amplitude can be determined by an experimental result or by experience.

In operation 530, it is determined whether the print column number n printed in operation 520 is equal to or greater than a threshold value S. In this embodiment, the threshold value S is a predetermined print column number at which the ink droplets begin to be ejected from all the nozzles since all the nozzles included in the print head are located on the color field.

When it is determined that the print column number n is less than the threshold value S in operation 530, the print column number n is set to n+1 in operation 540, and when ink droplets are ejected from the nozzle to the location in the print medium corresponding to the n-th print column or after a predetermined period of the time, the pressure wave with the predetermined amplitude is generated with respect to the predetermined nozzles in operation 520.

If it is determined that the print column number n is equal to or greater than the threshold value S in operation 530, the print column number n is set to n+1 in operation 550.

After operation 550 is performed, ink droplets are ejected from all the nozzles to the location on the print medium corresponding to the n-th print column in operation 560.

In operation 570, it is determined whether the print column number n printed in operation 560 is equal to or greater than a threshold value L. In this embodiment, the threshold value L is a predetermined print column number on which the ink droplets begin not to be ejected from some of the nozzles since the some nozzles included in the print head are located outside of the color field.

When it is determined that the print column number n is equal to or less than the threshold value L in operation 570, the print column number n is set to n+1 in operation 550, and the ink droplets are ejected from all the nozzles to the location on the print medium corresponding to the n-th print column in operation 560.

When it is determined that the print column number n is greater than the threshold value L in operation 570, the print column number n is set to n+1 in operation 571.

After operation 571 is performed, when the ink droplets are ejected from the nozzle to the location on the print medium corresponding to the n-th print column or after a predetermined period of the time, the pressure wave with the predetermined amplitude is generated with respect to the predetermined nozzles in operation 572. In this embodiment, the predetermined nozzles are the nozzles not to eject ink droplets to the nth print column since the print pattern width is not the same width as the nozzle pitch of the print head in a color filter print process. In addition, the amplitude of the pressure wave generated in operation 520 is the amplitude at which the ink droplets are not ejected, and the amplitude can be determined by an experimental result or by experience.

In operation 573, it is determined whether the n-th print column is the N-th column that is a termination column in operation 572. In this embodiment, the termination column is a final column in which a print job has to be terminated in a unit print job corresponding to one page.

When it is determined that a print column number n is equal to or less than a termination column number of N in operation 573, the print column number n is set to n+1 in operation 571, and when ink droplets are ejected from the nozzle to the location on the print medium corresponding to the n-th print column or after a predetermined period of the time, the pressure wave with the predetermined amplitude is generated for the predetermined nozzles in operation 572.

When it is determined that the print column number n is greater than the termination column number N in operation 415, it is determined whether more pages to be printed remain in operation 580.

If it is determined that more pages to be printed remain in operation 580, the print column number n is set to 0 to print the next page in operation 510.

The nozzle control methods illustrated in FIGS. 4 and 5 may be changed by substituting a heater for the pressure chamber included in the nozzle, substituting heat generated by the heater for the pressure wave in the pressure chamber, and analogizing a temperature of the heat to the amplitude of the pressure wave.

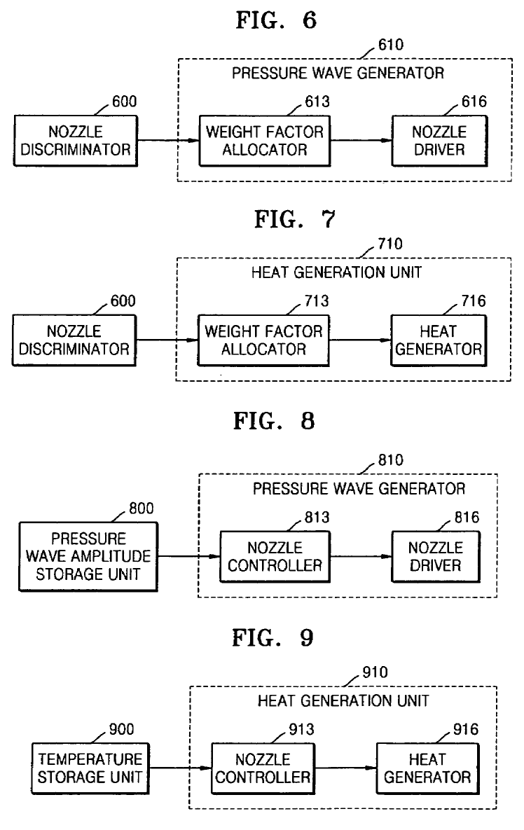

FIG. 6 is a block diagram illustrating a nozzle control device according to an embodiment of the present general inventive concept. The nozzle control device includes a nozzle discriminator 600 and a pressure wave generator 610.

The nozzle discriminator 600 discriminates between the nozzle to eject the ink droplets and the nozzle not to eject the ink droplets from the nozzles included in the print head when the job of ejecting the ink droplets is to be performed. In this embodiment, the nozzle not to eject the ink droplets is the nozzle located outside of the color field as in cases of positions 110, 120, 140, and 150 illustrated in FIG. 1A, since the print pattern width is not the same width as the nozzle pitch of the print head in a color filter print process, or the nozzle which passes a black matrix.

If the ink droplets are ejected from the discriminated nozzle to eject the ink droplets or after a predetermined period of the time has elapsed, even for the discriminated nozzle(s) not to eject the ink droplets by the nozzle discriminator 600, the pressure wave generator 610 generates the pressure wave with the predetermined amplitude. In this embodiment, the amplitude of the generated pressure wave is the amplitude at which the ink droplets are not ejected from the nozzles which are not to eject the ink droplets, and the amplitude can be determined by an experiment result or by experience. In addition, the pressure wave generator 610 includes a weight factor allocator 613 and a nozzle driver 616.

The weight factor allocator 613 allocates a weight factor relatively representing the amplitude of the pressure wave generated in each nozzle and outputs the drive waveform generated by the allocated weight factor in the nozzle. For example, FIG. 12A is a graph illustrating a weight factor which represents the amplitude of the pressure wave to be generated in each nozzle. Here, regions 1200 and 1220 correspond to the weight factor for the nozzles not to eject the ink droplets, and a region 1210 corresponds to the weight factor for the nozzles to eject the ink droplets. The drive waveform of the pressure wave illustrated in FIG. 12B is multiplied by the weight factor illustrated in FIG. 12A to obtain the drive waveform to be generated in the pressure chamber included in each nozzle as illustrated in FIG. 12C. When the pressure wave generated in the pressure chamber is controlled in accordance with the calculated drive waveform of the pressure wave in the regions 1200 and 1220, the ink droplets are not ejected and the pressure wave generated in the pressure chamber is only dispersed, and in the region 1210, the thickness of the ink ejected to the print medium is uniform as in the regions 170 and 190 illustrated in FIG. 1B and is uniform as in the region 180 illustrated in FIG. 1B.

In addition, FIG. 13 illustrates weight factors with respect to the print pattern used by the weight factor allocator 613. In the regions 1300 and 1320, the amplitude of the pressure wave is multiplied by the weight factor of 0.5, and in the region 1310 where the ink droplets are ejected from the nozzle, the amplitude of the pressure wave is multiplied by the weight factor of 1.

The nozzle driver 616 generates the pressure wave in the pressure chamber included in each nozzle in response to the drive waveform of the pressure wave output from the weight factor allocator 613. In this embodiment, in the nozzle driver 616, the ink droplets are not ejected from the nozzle not to eject the ink droplets and only a pressure wave is generated.

FIG. 7 is a block diagram illustrating a nozzle control device according to another embodiment of the present general inventive concept. The nozzle control device of FIG. 7 includes a nozzle discriminator 600 and a heat generation unit 710.

The nozzle discriminator 600 discriminates between the nozzle to eject the ink droplets and the nozzle not to eject the ink droplets from the nozzles included in the print head when the job of ejecting the ink droplets is to be performed. In this embodiment, the nozzle not to eject the ink droplets is the nozzle that is located outside of the color field as in cases of the positions 110, 120, 140, and 150 illustrated in FIG. 1A since the print pattern width is not the same width as the nozzle pitch of the print head in a color field print process, or the nozzle which passes a black matrix.

When the ink droplets are ejected from the discriminated nozzles to eject the ink droplets or after a predetermined period of time has elapsed, and even for the nozzles not to eject the ink droplets discriminated by the nozzle discriminator 600, the heat generation unit 710 heats up to a predetermined temperature. In this embodiment, the heating temperature is the temperature at which the ink droplets are not ejected from the nozzles not to eject the ink droplets, and the temperature can be determined by an experimental result or by experience. In addition, the heat generation unit 710 includes a weight factor allocator 713 and a heat generator 716.

The weight factor allocator 713 allocates a weight factor relatively representing the temperature of the heat generated in each nozzle.

The heat generator 716 generates the heat in the heater included in each nozzle in response to the weight factor allocated by the weight factor allocator 713.

In this embodiment, in the heat generator 716, the ink droplets are not ejected from the nozzles not to eject the ink droplets, and only heat is generated by the heat generator 716.

FIG. 8 is a block diagram illustrating a nozzle control device according to yet another embodiment of the present general inventive concept. The nozzle control device of FIG. 8 includes a pressure wave amplitude storage unit 800 and a pressure wave generator 810.

The pressure wave amplitude storage unit 800 stores an amplitude of the pressure wave to be generated in each nozzle included in the print head in correspondence with each print column. In this embodiment, the pressure wave amplitude storage unit 800 stores the amplitude of the pressure wave to be generated in the pressure chamber included in the nozzles in which the ink droplets are not ejected from the nozzles that are not to eject the ink droplets. The amplitude can be determined by an experimental result or by experience. The nozzles not to eject the ink droplets are the nozzles that are not located in the color field as in cases of positions 110, 120, 140 and 150 illustrated in FIG. 1A, since the print pattern width is not the same width as the nozzle pitch of the print head in a color filter print process, or the nozzle which passes a black matrix.

The pressure wave generator 810 reads the amplitude of the pressure wave with respect to each nozzle stored in the pressure wave amplitude storage unit 800 and generates the pressure wave in the pressure chamber included in each nozzle. In this embodiment, the pressure wave generator 810 includes a nozzle controller 813 and a nozzle driver 816.

The nozzle controller 813 reads the amplitude of the pressure wave stored in the pressure wave amplitude storage unit 800 with respect to the print column to be currently printed and outputs a control signal to generate the pressure wave in accordance with the read pressure wave amplitude in the pressure chamber included in each nozzle.

In the nozzle driver 816, the ink droplets are ejected from each nozzle by generating the pressure wave in the pressure chamber included in each nozzle in response to the control signal output from the nozzle controller 813, and only the pressure wave is generated in the nozzles not to eject the ink droplets.

FIG. 9 is a block diagram illustrating a nozzle control device according to yet another embodiment of the present general inventive concept. The nozzle control device of FIG. 9 includes a temperature storage unit 900 and a heat generation unit 910.

The temperature storage unit 900 stores heat temperature generated in each nozzle included in the print head in correspondence with each print column. In this embodiment, the temperature storage unit 900 stores the heat temperature to be generated in the heater included in the nozzle in which the ink droplets are not ejected from the nozzles that are not ejecting the ink droplets. The amplitude can be determined by an experimental result or by experience. The nozzles not to eject the ink droplets are the nozzles that are located outside of the color field as in the cases of positions 110, 120, 140 and 150 illustrated in FIG. 1A, since the print pattern width is not the same width as the nozzle pitch of the print head in a color filter print process, or the nozzle which passes a black matrix.

The heat generation unit 910 reads the heat temperature to be generated with respect to each nozzle stored in the temperature storage unit 900 and heats up from the heater included in each nozzle. In this embodiment, the heat generation unit 910 includes a nozzle controller 913 and a heat generator 916.

The nozzle controller 913 reads the heat temperature to be generated and that is stored in the temperature storage unit 900 with respect to the print column to be currently printed, and outputs a control signal to generate heat in accordance with the read temperature of the heat in the heater included in each nozzle.

In the heat generator 916, the ink droplets are ejected from each nozzle by generating heat in the heater included in each nozzle in response to the control signal output from the nozzle controller 913, and only heat is generated in the nozzle not to eject the ink droplets.

The present general inventive concept can also be embodied as computer readable code on a computer (such as a device with information processing function) readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard disks, floppy disks, and optical data storage devices.

While the nozzle control devices and methods according to the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

According to the nozzle control devices and methods of the present general inventive concept, the thickness of ink is uniform by generating a pressure wave with an amplitude at which ink droplets are not ejected in a pressure chamber of the nozzle not to eject the ink droplets and generating heat to the temperature at which ink droplets are not ejected in a heater of the nozzle not to eject the ink droplets when the ink droplets are ejected.

Accordingly, it is possible to produce a color filter with a uniform thickness regardless of the print pattern. The ink droplets with constant size can be ejected when the nozzle pitch of the print head is not the same width as the print pattern width. Therefore, the print quality is improved by a uniform ink thickness for which the print job is performed to the print medium regardless of the number of nozzles ejecting the ink droplets concurrently.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A nozzle control method of controlling nozzles in an image forming apparatus to eject ink droplets from a plurality of nozzles using a pressure wave, the method comprising:
discriminating between a nozzle to eject the ink droplets from a nozzle not to eject ink droplets; and
generating a pressure wave with a predetermined amplitude in the nozzle not to eject the ink droplets when the ink droplets are ejected from the nozzle to eject the ink droplets.

2. The method of claim 1, wherein the amplitude of the pressure wave generated in the generation of the pressure wave is predetermined as the amplitude at which the ink droplets are not ejected from the nozzles not to eject the droplets.

3. The method of claim 1, wherein the generating of the pressure wave comprises:
allocating a weight factor to represent the amplitude of the pressure wave generated in each nozzle that is less than a weight factor allocated to the nozzle to eject the ink droplets to the nozzle not to eject the ink droplets; and
generating the pressure wave in each nozzle in accordance with the allocated weight factor.

4. The method of claim 1, wherein discriminating between the nozzles is performed at a predetermined time.

5. The method of claim 1, wherein discriminating between the nozzles is performed while the ink droplets are ejected from some of the nozzles.

6. The method of claim 1, wherein discriminating between the nozzles is performed while some of the nozzles are located outside of a color field.

7. A computer-readable recording medium having embodied thereon a computer program to execute a method of controlling nozzles in an image forming apparatus to eject ink droplets from a plurality of nozzles using a pressure wave, the method comprising:
discriminating between nozzles to eject the ink droplets from nozzles not to eject ink droplets; and
generating a pressure wave with a predetermined amplitude in the nozzles not to eject the ink droplets when the ink droplets are ejected from the nozzles to eject the ink droplets.

8. A nozzle control device to control nozzles in an image forming apparatus to eject ink droplets from a plurality of nozzles using a pressure wave, the device comprising:
a nozzle discriminator to discriminate between nozzles to eject the ink droplets from nozzles not to eject the ink droplets; and
a pressure wave generator to generate a pressure wave with a predetermined amplitude in the nozzles not to eject the ink droplets when the ink droplets are ejected from the nozzles to eject the ink droplets.

9. The device of claim 8, wherein the amplitude of the pressure wave generated in the pressure wave generator is predetermined as the amplitude at which the ink droplets are to be not ejected from the nozzles not to eject the ink droplets.

10. The device of claim 8, wherein the pressure wave generator comprises:
a weight factor allocator to allocate a weight factor to represent the amplitude of the pressure wave generated in each nozzle that is less than a weight factor allocated to the nozzle to eject the ink droplets to the nozzle not to eject the ink droplets; and
a nozzle driver to generate the pressure wave in each nozzle in accordance with the allocated weight factor.

11. The device of claim 8, wherein the nozzle discriminator operates at a predetermined time.

12. The device of claim 8, wherein the nozzle discriminator operates while the ink droplets are ejected from a portion of the nozzles.

13. The device of claim 8, wherein the nozzle discriminator operates while a portion of the nozzles are located outside of a color field.

14. A nozzle control method of controlling nozzles in an image forming apparatus so as to eject ink droplets from a plurality of nozzles using heat, the method comprising:
discriminating between the nozzles to eject the ink droplets from the nozzles not to eject the ink droplets; and
generating the heat of a predetermined temperature in the nozzles not to eject the ink droplets when the ink droplets are ejected from the nozzles to eject the ink droplets.

15. The method of claim 14, wherein a heat temperature generated is predetermined as the temperature at which the ink droplets are not ejected.

16. A nozzle control device to control nozzles in an image forming apparatus to eject ink droplets from a plurality of nozzles using heat, the device comprising:
a nozzle discriminator to discriminate between nozzles to eject the ink droplets from nozzles not to eject the ink droplets; and
a heat generation unit to generate heat to a predetermined temperature in the nozzles not to eject the ink droplets when the ink droplets are ejected from the nozzles to eject the ink droplets.

17. The device of claim 16, wherein a heat temperature generated in the heat generation unit is predetermined as the temperature at which the ink droplets are not ejected.

18. A nozzle control method of controlling nozzles in an image forming apparatus to eject ink droplets from a plurality of nozzles using a pressure wave, the method comprising:
reading an amplitude of the pressure wave from a storage medium in which the amplitude of the pressure wave with respect to each nozzle is stored in correspondence with a location on a print medium to which the ink droplets are to be ejected; and
generating the pressure wave in each nozzle in accordance with the amplitude of the read amplitude of the pressure wave,
wherein the storage medium stores the predetermined amplitude of the pressure wave so that the pressure wave is generated with respect to the nozzles not to eject the ink droplets.

19. The method of claim 18, wherein the amplitude of the pressure wave is stored in the storage medium so that the ink droplets are not ejected from the nozzles not to eject the droplets.

20. A nozzle control device to control nozzles in an image forming apparatus so as to eject ink droplets from a plurality of nozzles using a pressure wave, the device comprising:
a pressure wave amplitude storage unit to store an amplitude of the pressure wave with respect to each nozzle in correspondence with a location on a print medium to which the ink droplets are ejected; and
a pressure wave generator to generate the pressure wave in each nozzle in accordance with the amplitude of the pressure wave stored in the pressure wave amplitude storage unit, wherein the predetermined amplitude of the pressure wave is stored in the pressure wave amplitude storage unit so that the pressure wave is generated in the pressure wave generator with respect to the nozzle not to eject the ink droplets.

21. The method of claim 20, wherein the amplitude of the pressure wave is stored in the pressure wave amplitude storage unit so that the ink droplets are not ejected from the nozzles not to eject the droplets.

22. A nozzle control method of controlling nozzles in an image forming apparatus to eject ink droplets from a plurality of nozzles using a pressure wave, the method comprising:
reading a heat temperature from a storage medium in which the heat temperature to be generated is stored with respect to each nozzle in correspondence with a location on a print medium to which the ink droplets are ejected; and
generating heat in each nozzle in accordance with the read temperature,
wherein the predetermined heat temperature is stored in the storage medium so that heat is generated with respect to the nozzles not to eject the ink droplets.

23. The method of claim 22, wherein the heat temperature is stored in the storage medium so that the ink droplets are not ejected from the nozzles not to eject the droplets.

24. A nozzle control device to control nozzles in an image forming apparatus so as to eject ink droplets from a plurality of nozzles using a pressure wave, the device comprising:
a temperature storage unit to store a heat temperature to be generated in each nozzle in correspondence with a location on a print medium to which the ink droplets are ejected; and
a heat generation unit to generate heat in each nozzle in accordance with the temperature stored in the temperature storage unit, wherein the predetermined heat temperature is stored in the temperature storage unit so that heat is generated with respect to the nozzles not to eject the ink droplets.

25. The device of claim 24, wherein the heat temperature is stored in the temperature storage unit so that the ink droplets are not ejected from the nozzles not to eject the droplets.

26. A nozzle controlling device to control a nozzle in an image forming apparatus so as to eject ink droplets from a plurality of nozzles, the device comprising:
a nozzle discriminator to discriminate nozzles to eject the ink droplets from nozzles not to eject the ink droplets; and
a generator to drive the nozzles such that the nozzles to eject the ink droplets eject the ink droplets and the nozzles not to eject the ink droplets do not eject the ink droplets.

27. The nozzle control device of claim 26, wherein the generator is a pressure wave generator that applies a distributed pressure wave to all of the nozzles such that the nozzles to eject the ink droplets do eject the ink droplets and the nozzles not to eject the ink droplets do not eject the ink droplets.

28. The control device of claim 26, wherein the generator is a heat generation unit to apply a distributed heat to all of the nozzles such that the nozzles to eject the ink droplets do eject the ink droplets and the nozzles not to eject the ink droplets do not eject the ink droplets.

29. A method of controlling nozzles in an image forming apparatus, the method comprising:
determining which nozzles of a plurality of nozzles are to eject the ink droplets; and
generating a pressure wave with a predetermined amplitude and applying the pressure wave to the plurality of nozzles to eject the ink droplets.

30. The method of claim 29, wherein an amplitude of the pressure wave generated is controlled using a weight factor which relatively represents the amplitude of the pressure wave generated in each nozzle.

31. The method of claim 30, wherein the pressure wave generated in the nozzle to eject the ink droplets is dispersed over the nozzles not to eject the ink droplets.

32. The method of claim 30, wherein in regions where the ink droplets are not to be ejected from some nozzles, the amplitude of the pressure wave is multiplied by a weight factor of 0.5, and in a region where the ink droplets are to be ejected from all nozzles, the amplitude of the pressure wave is multiplied by a weight factor of 1.
